(19) United States
(12) Patent Application Publication
(10) Pub. No.: US 2015/0102181 A1
(43) Pub. Date: Apr. 16, 2015

(54) Furcated Eye Bolt Assembly

(71) Applicant: Wesley K. Hook, Toney, AL (US)

(72) Inventor: Wesley K. Hook, Toney, AL (US)

(21) Appl. No.: 14/052,358

(22) Filed: Oct. 11, 2013

(51) Int. Cl. F16L 3/22; F16M 13/02

(52) U.S. Cl. CPC F16L 3/22; F16M 13/02
USPC 248/68.1

(57) ABSTRACT

A furcated eye bolt assembly includes a bolt with a head having a plurality of openings defined by a corresponding plurality of rings.

### BRIEF DESCRIPTION OF THE DRAWINGS

The apparatus is described with reference to the accompanying drawings. In the drawings, like reference numbers indicate identical or functionally similar elements.

FIG. 1 is depicts an exemplary bi-furcated embodiment of the eye bolt assembly;

FIG. 2 is depicts a tri-furcated embodiment of the eye bolt assembly; and

FIG. 3 is a side view of a bolt head.

### DETAILED DESCRIPTION

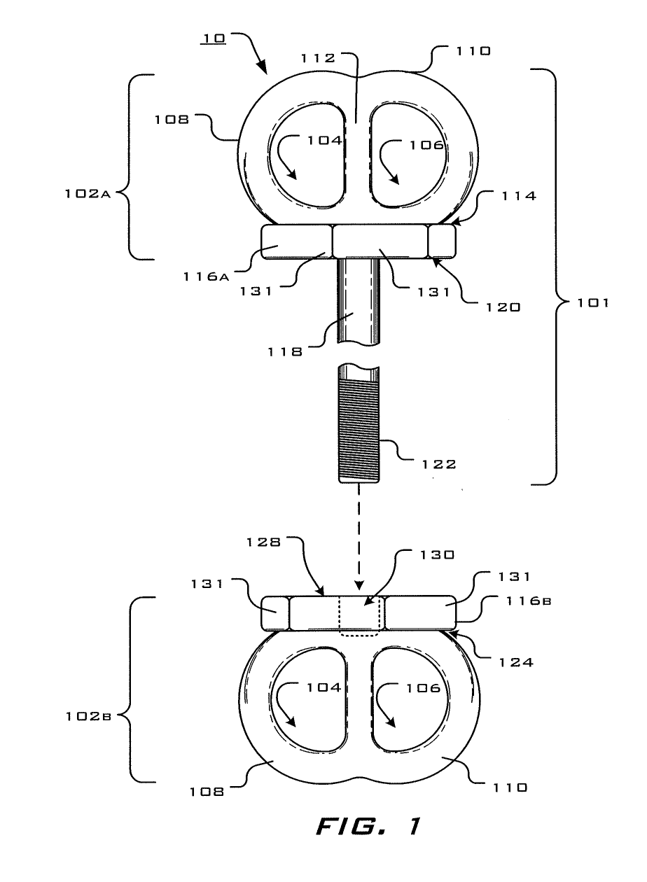

The embodiments of the furcated eye bolt assembly and their advantages are best understood by referring to FIGS. 1 through 3 of the drawings. The elements of the drawings are not necessarily to scale, emphasis instead being placed upon clearly illustrating the principles set forth in this description.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

As shown in FIG. 1, a first exemplary embodiment of the eye bolt assembly 10 comprises a bolt 101 with a first head 102a, that includes two roughly semicircular openings 104, 106. The openings 104, 106 are defined by rings 108, 110 separated by a divider 112. Rings 108, 110 may be closed or nearly closed such that anything inserted therein does not become unengaged with the openings or comes into contact with anything engaging an adjacent opening. The rings 108, 110 and the divider 112 preferably extend from a first side 114 of a cap 116a. As shown in FIG. 3, the rings, and therefore the openings, lie in one plane.

Advantageously, the cap 116a may comprise a plurality of circumferentially disposed flat surfaces 131 which may be engaged by a wrench or pliers for tightening or loosening. For example, the cap may comprise a hexagonal shape with six such surfaces 131. It will be appreciated that the cap 116a may comprise more, or fewer, flat surfaces 131. The bolt 101 further comprises a shank 118 extending from a second side 120 of the cap 116a. The protruding end of the shank 118 has a male threaded portion 122.

The assembly 10 may comprise a conventional nut (not shown) for fastening the bolt by threadably engaging the male threaded portion 122. Alternatively, the bolt 101 may be fastened with a second head 102b similarly comprises rings 108, 110 extending from a first side 124 of a second cap 116b also comprising a plurality of circumferential flat surfaces 131. A female threaded recess 130 dimensioned to receive and threadably engage the male threaded portion 122 is defined in a second side 128 of the cap 116b

In use, the shank 118 is inserted through a pre-drilled hole in a utility pole (not shown). The male threaded portion 122 of the shank 118 is then fed into the female threaded recess 130 of the second head 102b. Wrenches may then be used on the caps 116a, 116b to tighten the assembly and firmly secure it to the utility pole. A separate power line is then attached to each opening 104, 106 of the assembly, allowing for complete separation of the lines.

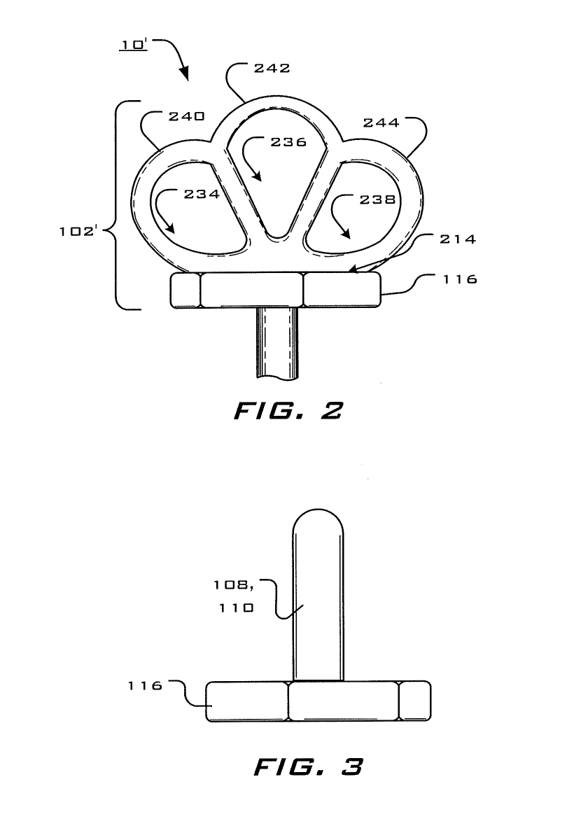

As shown in FIG. 2, a second embodiment of the eye bolt assembly 10′ is illustrated with a tri-aperture head 102′ comprising three openings 234, 236, 238 defined by rings 240, 242, 244 and separated by dividers 246, 248. As in the previous embodiment, the rings 240, 242, 244 extend from a first side 214 of a cap 116. The remainder of the tri-aperture eye bolt assembly embodiment is similar in design and use to the bi-aperture embodiment shown in FIG. 1. For example, the tri-aperture assembly may include a second head configured with tri-aperture rings with a threaded female recess to threadably engage a threaded male bolt extending from the tri-aperture head 102′.

As described above and shown in the associated drawings, the present invention comprises a furcated eye bolt assembly. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. An eye bolt assembly comprising:
a head with a first plurality of rings, each said ring defining an opening; and
a shank extending from said head, said shank configured with a threaded end.

2. The eye bolt of claim 1, further comprising a fastener, said fastener comprising a second head with a second plurality of rings, each said ring of said second plurality defining an opening, and wherein said fastener is configured to engage said shank.

3. The eye bolt of claim 1, wherein said first plurality of rings is three rings.

4. The eye bolt of claim 3, wherein said second plurality of rings is three rings.

5. A furcated eye bolt comprising a head with multiple eyes formed of multiple rings.

6. The furcated eye bolt of claim 5, wherein said multiple eyes comprises three eyes.
